(19) United States
(12) Patent Application Publication
(10) Pub. No.: US 2022/0259091 A1
(43) Pub. Date: Aug. 18, 2022

(54) GLASS PLATE PROCESSING METHOD, GLASS PLATE

(71) Applicant: AGC Inc., Tokyo (JP)

(72) Inventors: Isao SAITO, Tokyo (JP); Takuma FUJIWARA, Tokyo (JP); Takeaki ONO, Tokyo (JP)

(73) Assignee: AGC Inc., Tokyo (JP)

(21) Appl. No.: 17/738,693

(22) Filed: May 6, 2022

Related U.S. Application Data
(63) Continuation of application No. PCT/JP2020/041410, filed on Nov. 5, 2020.

(30) Foreign Application Priority Data
Nov. 21, 2019 (JP) 2019-210500

(51) Int. Cl. C03B 33/02

(52) U.S. Cl. CPC C03B 33/0222

(57) ABSTRACT

A large plate includes a first main surface and a second main surface, and is separated into a first small plate and a second small plate at a separation surface. The separation surface intersects with the first main surface and the second main surface at a first intersection line and a second intersection line, respectively. The first intersection line and the second intersection line include a curved portion. The first intersection line is disposed on one side of the second intersection line in a planar view. In a cross-section perpendicular to the first intersection line, the separation surface is inclined with respect to a normal to the first main surface. (1) Form a modified portion on the separation surface to be separated. (2) Form a crack on the separation surface. (3) Separate the first and second small plate.

### CROSS-REFERENCE TO RELATED APPLICATIONS

This application is a continuation of International Application No. PCT/JP2020/041410, filed on Nov. 5, 2020 and designating the U.S., which claims priority to Japanese Patent Application No. 2019-210500 filed on Nov. 21, 2019. The contents of these applications are incorporated herein by reference in their entirety.

### BACKGROUND OF THE INVENTION

### 1. Field of the Invention

The present invention relates to a glass plate processing method and a glass plate.

### 2. Description of the Related Art

In Patent Document 1, laser light is illuminated on a substrate, which is a glass plate, and multiple micro-fractures are formed inside the large plate. The multiple micro-fractures are formed on a separation surface that separates the substrate into a first small plate and a second small plate. Subsequently, by applying stress to the glass plate and forming cracks on the separation surface, the substrate can be separated into the first small plate and the second small plate at the separation surface.

In Patent Document 1, when the substrate is separated into the first small plate and the second small plate in the form of a frame surrounding the first small plate, the second small plate is further crushed into a number of pieces to obtain the first small plate.

An aspect of the present disclosure provides a technique in which separation can be performed when a large plate is separated into a first small plate and a second small plate, with no crushing of both the first small plate and the second small plate.

### RELATED-ART DOCUMENTS

### Patent Documents

Patent Document 1: Japanese Laid-Open Patent Publication No. 2019-64916

### SUMMARY OF THE INVENTION

A method of processing a glass plate according to an embodiment of the present disclosure, a large plate includes a first main surface and a second main surface, and is separated into a first small plate and a second small plate at a separation surface. The separation surface intersects with the first main surface and the second main surface at a first intersection line and a second intersection line, respectively, the first intersection line and the second intersection line include a curved portion. The first intersection line is disposed on one side of the second intersection line in a planar view. In a cross-section perpendicular to the first intersection line, the separation surface is inclined with respect to a normal to the first main surface. The method of processing includes the following (1) to (3). (1) Form a modified portion on the separation surface to be separated by concentrating laser light inside the large plate. (2) Form, after forming the modified portion, a crack on the separation surface by applying stress to the large plate. (3) Separate, after forming the crack, the first small plate and the second small plate by displacing the first small plate and the second small plate in a direction of the normal to the first main surface.

According to an embodiment, separation can be performed when a large plate is separated into a first small plate and a second small plate with no crushing of both the first small plate and the second small plate.

### BRIEF DESCRIPTION OF THE DRAWINGS

FIG. 1 is a flowchart illustrating a glass plate processing method according to a first embodiment;

FIG. 2A is a plan view illustrating S1 of FIG. 1;

FIG. 2B is a cross-sectional view illustrating S1 of FIG. 1 and is a cross-sectional view along line IIB-IIB of FIG. 2A;

FIG. 3 is a cross-sectional view illustrating S2 of FIG. 1;

FIG. 4 is a cross-sectional view illustrating S3 of FIG. 1;

FIG. 5 is a cross-sectional view illustrating S4 of FIG. 1;

FIG. 6 is a cross-sectional view illustrating S5 of FIG. 1;

FIG. 7 is a flowchart illustrating a glass plate processing method according to a second embodiment;

FIG. 8 is a cross-sectional view illustrating S6 of FIG. 7; and

FIG. 9 is a plan view illustrating a separation surface of a glass plate according to a third embodiment.

### DESCRIPTION OF THE EMBODIMENTS

In the following, embodiments will be described with reference to the accompanying drawings. Note that, in each drawing, the same or corresponding configuration is indicated by the same reference numerals and the description thereof may be omitted. In the description, a “˜” indicating a numerical range means that the numerical range described includes the lower limit value and the upper limit value (i.e., the values respectively before and after the “˜” symbol).

### First Embodiment

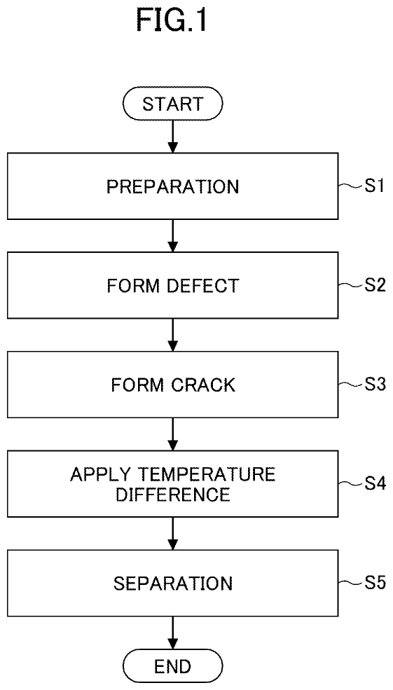

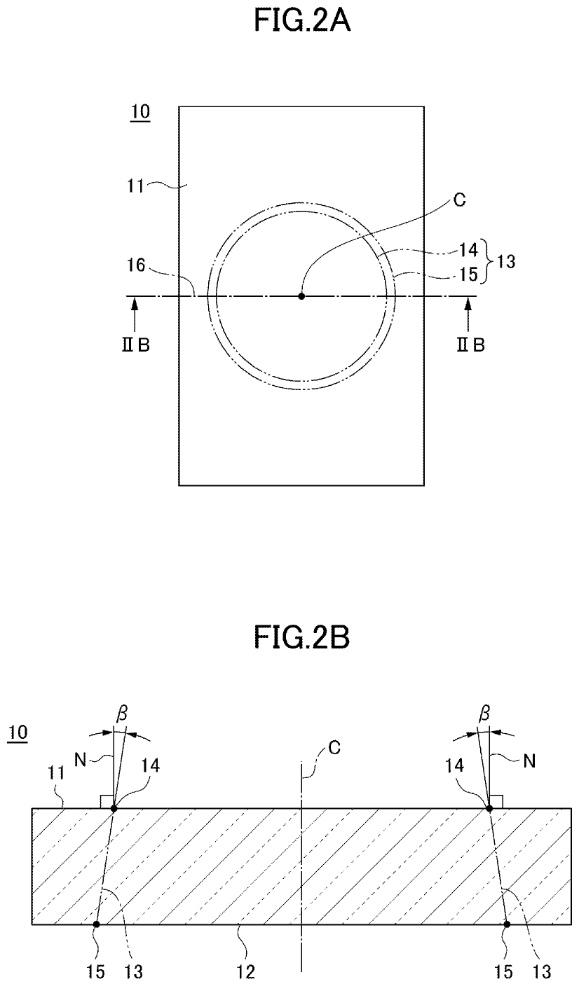

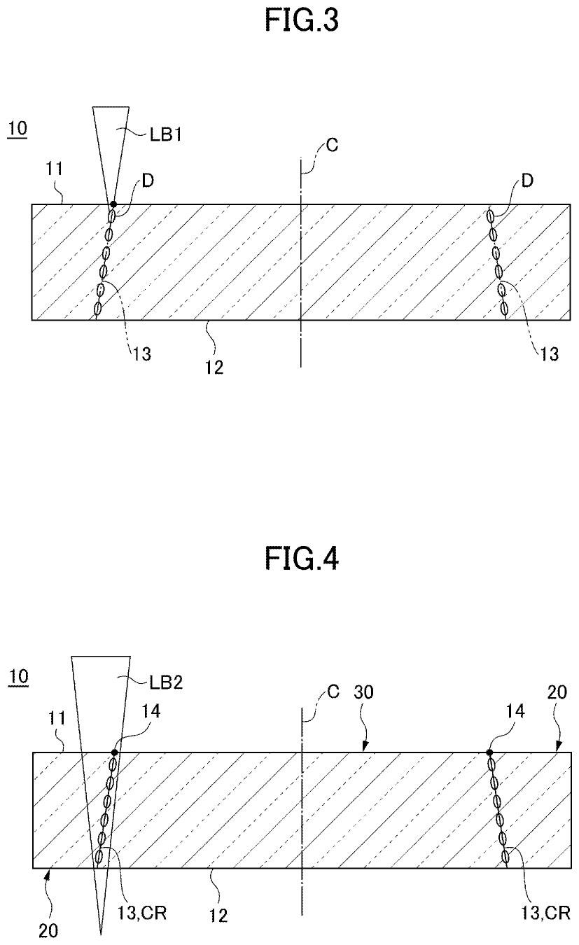

As illustrated in FIG. 1, a glass plate processing method includes S1 to S5. Hereinafter, S1 to S5 of FIG. 1 will be described with reference to FIG. 2A, FIG. 2B, and FIG. 3 to FIG. 6.

First, in S1 of FIG. 1, a large plate 10 is prepared as illustrated in FIG. 2A and FIG. 2B. The large plate 10 is a glass plate. The large plate 10 may be a bent plate, but in the present embodiment, the large plate 10 is a flat plate. The large plate 10 includes a first main surface 11 and a second main surface 12 facing opposite of the first main surface 11. When the large plate 10 is a curved plate, the large plate 10 may be a single-curved shape curved in a single direction, or the large plate 10 may be a multi-curved shape curved in both a longitudinal direction and a transverse direction. When the large plate 10 is the single-curved shape, a radius of curvature of the large plate 10 is preferably 5000 mm or more and 100,000 mm or less. When the large plate 10 is the multi-curved shape, a radius of curvature of the large plate 10 is preferably 1,000 mm or more and 100,000 mm or less. The bend-shaping of the large plate 10 is softened by heating glass to a temperature of 550° C. to 700° C. As a method of bend-shaping of the large plate 10, gravity forming, press forming, roller forming, vacuum molding, and the like are used.

The shapes of the first main surface 11 and the second main surface 12 are, for example, rectangular. Note that the shapes of the first main surface 11 and the second main surface 12 may be trapezoidal, circular, or elliptical, and are not particularly limited.

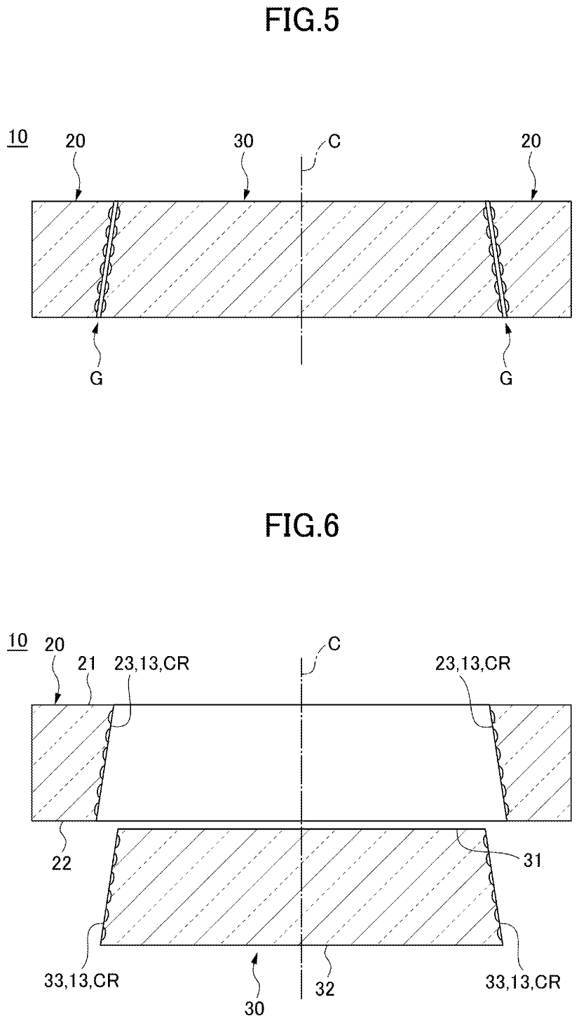

The large plate 10 is separated into a first small plate 20 and a second small plate 30 on a separation surface 13 as illustrated in FIG. 6. Therefore, the first small plate 20 and the second small plate 30 are smaller than the large plate 10. Either of the first small plate 20 and the second small plate 30 may be larger than the other.

For example, the first small plate 20 is a product and the second small plate 30 is a non-product, i.e., a waste item. Note that the second small plate 30 may be a product and the first small plate 20 may be a non-product. Further, both the first small plate 20 and the second small plate 30 may be products.

Since the large plate 10 is a glass plate, both the first small plate 20 and the second small plate 30 are naturally glass plates.

Applications for glass plates are automotive windows, instrument panels, head-up displays (HUDs), covers for automotive interior parts (such as dashboards, center consoles, and shift knobs), construction windows, substrates for displays, or cover glass for displays. The thickness of the glass plate, which is a product, may be set, for example, from 0.01 cm to 2.5 cm, according to an application of the product.

The glass plate, which is a product, may be laminated via another glass plate and interlayer after S1 to S5 of FIG. 1 and used as the laminated glass. Further, the glass plate, which is a product, may be subjected to tempering treatment after S1 to S5 of FIG. 1 and used as tempered glass.

The product glass includes, for example, soda lime glass, alkali-free glass, and glass for chemical tempering. The glass for chemical tempering is used, for example, as cover glass after being chemically tempered. The product glass may be air-cooled glass.

The glass plate, which is a product, may be bend-shaped after S1 to S5 of FIG. 1, or may be formed after bend-shaping the large plate 10, i.e., by performing S1 to S5 of FIG. 1 on the large plate 10 curved in a single-curved or a multi-curved shape, thereby obtaining a glass plate which is a product. That is, the glass plate, which is a product, may be curved into the single-curved shape or the multi-curved shape.

As illustrated in FIG. 2A and FIG. 2B, the separation surface 13 includes a first intersection line 14 that intersects the first main surface 11 and a second intersection line 15 that intersects the second main surface 12. The first intersection line 14 includes, for example, a curved portion. The first intersection line 14 does not have a straight portion, but may have a straight portion as described below. The second intersection line 15 also includes a curved portion similar to the first intersection line 14. The second intersection line 15 includes the curved portion with the center of curvature C that is the same as the first intersection line 14. The center of curvature C is included in the second small plate 30.

As illustrated in FIG. 2A, the first intersection line 14 is disposed on one side of the second intersection line 15 in a planar view. Specifically, for example, the first intersection line 14 is disposed on the center of curvature C side, that is, inside of the second intersection line 15 in the radial direction, with the second intersection line 15 as the reference. The disposition of the first intersection line 14 and the second intersection line 15 may be reversed, and the first intersection line 14 may be disposed on the side opposite to the center of curvature C, that is, outside of the second intersection line 15 in the radial direction, with the second intersection line 15 as the reference.

As illustrated in FIG. 2B, at a cross-section 16 orthogonal to the first intersection line 14, the separation surface 13 is inclined with respect to a normal N to the first main surface 11. The separation surface 13 is, for example, a linear taper. An angle β between the normal N to the first main surface 11 and the separation surface 13 is, for example, 3° to 45°.

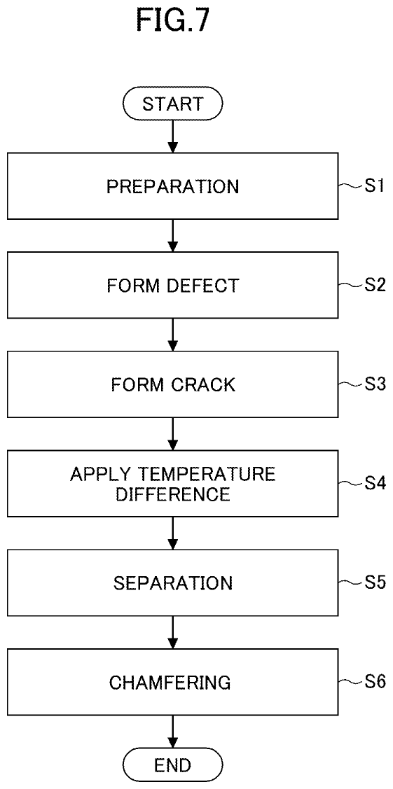

When the β is 3° or more, the first small plate 20 and the second small plate 30 can be displaced in the direction of the normal to the first main surface 11 as illustrated in FIG. 6, as will be described later in detail. On the other hand, when the β is not more than 45°, chipping on the separation surface 13 of the product can be prevented. Also, as illustrated in FIG. 7, if S6 (chamfering) is further processed after S5, the β is preferably 3° to 20°.

Note that the separation surface 13 is a linear taper in the present embodiment, but may be a non-linear taper. In this case, the β is the angle between the normal N to the first main surface 11 and a tangent to the separation surface 13. The range of the β is preferably within the above range.

Next, in S2 of FIG. 1, as illustrated in FIG. 3, first laser light LB1 is concentrated in a dot shape inside the large plate 10, and a dot-shaped modified portion D (later-described) is formed at the light concentration point. The first laser light LB1 is pulsed light and forms the modified portion D by nonlinear absorption. The nonlinear absorption is also called multiphoton absorption. The probability that the multiphoton absorption occurs is non-linear with respect to the photon density (power density of the first laser light LB1), and the probability increases dramatically as the photon density is high. For example, the probability that two-photon absorption occurs is proportional to the square of the photon density.

The pulsed light preferably uses pulsed laser light having a wavelength range of 250 nm to 3,000 nm and a pulse width of 10 fs to 1,000 ns. The laser light in the wavelength range 250 nm to 3,000 nm penetrates through the large plate 10 to some extent, so that nonlinear absorption can occur inside the large plate 10 to form the modified portion D. The wavelength range is preferably 260 nm to 2,500 nm. When the pulse width is 1,000 ns or less, the photon density can be easily increased, and nonlinear absorption can be generated inside the large plate 10 to form the modified portion D. The pulse width is preferably from 100 fs to 100 ns.

A light source of the first laser light LB1 may include, for example, an Nd-doped YAG crystal (Nd:YAG) to output pulsed light at a wavelength of 1064 nm. Note that the wavelength of the pulsed light is not limited to 1,064 nm. Nd;YAG second harmonic laser (wavelength of 532 nm) or Nd;YAG third harmonic laser (wavelength of 355 nm) can also be used. The light source of the first laser light LB1 repeatedly outputs pulsed light of a group of pulses or a single pulsed light.

The first laser light LB1 is concentrated by an optical system that includes a condenser lens or the like. The modified portion D is glass with a change in density or a change in refractive index. The modified portion D is a void, a modified layer, or the like. The modified layer is a layer whose density or refractive index has changed due to structural changes, or due to melting and resolidification.

The modified portion D repeats the two-dimensional movement of the light concentration point in a plane having a constant depth from the first main surface 11 and change of the depth of the light concentration point from the first main surface 11 so that the modified portion D is dispersedly disposed on the separation surface 13. For example, a 3D Galvano scanner may be used to move the light concentration point. If the depth of the light concentration point is changed by moving the stage, a 2D Galvano scanner may be used.

The stage holds the large plate 10. The movement of the light concentration point may be performed by movement or rotation of the stage holding the large plate 10. For example, an XY stage, an XYθ stage, an XYZ stage, or an XYZ θ stage may be used as a stage. The X-axis, Y-axis, and Z-axis are orthogonal to each other, the X-axis and Y-axis are parallel to the first main surface 11, and the Z-axis is perpendicular to the first main surface 11.

The modified portion D is formed from the first main surface 11 to the second main surface 12 over the entire plate thickness direction. Here, the entire plate thickness direction means an area of 80% or more of the plate thickness. Within this area, multiple dot-shaped modified portions D may be formed at spaced intervals in the plate thickness direction, or a linear modified portion D may be continuously formed. In either case, in S3 of FIG. 1, a crack CR can be formed over the entire plate thickness direction.

When forming the modified portion D, the first laser light LB1 may be optically concentrated linearly in the optical axis direction by an optical system that includes a condenser lens or the like. In this case, a linear modified portion D is formed. Further, when forming the modified portion D, the first laser light LB1 may simultaneously generate multiple light concentration spots in the optical axis direction using a multi-focus optical system. Multiple dot-shaped modified portions D are simultaneously formed. The first laser light LB1 may be illuminated obliquely with respect to the first main surface 11, and the optical axis of the first laser light LB1 may be on the separation surface 13.

Next, in S3 of FIG. 1, stress is applied to the large plate 10 to form a crack CR formed on the separation surface 13 as illustrated in FIG. 4. The crack CR is formed starting from the modified portion D. Further, the cracks CR are formed from the first main surface 11 to the second main surface 12.

In the formation of the crack CR, for example, thermal stress is applied to the large plate 10 by irradiation of second laser light LB2. The second laser light LB2 generates mainly linear absorption upon irradiation with respect to the large plate 10. The linear absorption mainly generated means that the amount of heat generated by the linear absorption is greater than that generated by the nonlinear absorption. Nonlinear absorption is not required to occur appreciably. At any position on the large plate 10, the photon density may be less than 1×10⁸ W/cm². In this case, the nonlinear absorption does not readily occur. The heat generated by the second laser light LB2 forms a crack CR.

The linear absorption is also called a single-photon absorption. The probability of occurrence of the single-photon absorption is proportional to the photon density. In the case of single-photon absorption, the following Formula (1) follows Lambert-Beer's law.

I=I0×exp(−α×L) (1)

In Formula (1) described above, I0 is the intensity of the first laser light LB1 on the first main surface 11, I is the intensity of the first laser light LB1 on the second main surface 12, L is the propagation distance of the first laser light LB1 from the first main surface 11 to the second main surface 12, and α is an absorption coefficient of the glass with respect to the first laser light LB1. α is the absorption coefficient of the linear absorption and is determined by the wavelength of the first laser light LB1, the chemical composition of the glass, and the like.

α×L represents an internal transmittance. The internal transmittance is a transmittance assuming that the first laser light LB1 is not reflected at the first main surface 11. The smaller the α×L, the greater the internal transmittance. α×L is, for example, 3.0 or less, more preferably 2.3 or less, and further preferably 1.6 or less. In other words, the internal transmittance is, for example, 5% or more, preferably 10% or more, and further preferably 20% or more. When α×L is 3.0 or less, the internal transmittance is 5% or more, and both sides of the first main surface 11 and the second main surface 12 are sufficiently heated.

In terms of heating efficiency, α×L is preferably 0.002 or more, more preferably 0.01 or more, and further preferably 0.02 or more. In other words, the internal transmission is preferably 99.8% or less, more preferably 99% or less, and further preferably 98% or less.

When the temperature of the glass exceeds an annealing point, plastic deformation of the glass is likely to progress, and generation of the thermal stress is limited. Therefore, the light wavelength, an output, a beam diameter at the first main surface 11, or the like are adjusted such that the temperature of the glass becomes equal to or lower than the annealing point.

The second laser light LB2 is, for example, continuous wave light. A light source of the second laser light LB2 is, for example, a Yb fiber laser, but is not particularly limited. The Yb fiber laser is a fiber optic core doped with Yb and outputs continuous wave light of 1070 nm.

However, the second laser light LB2 may be pulsed light rather than continuous wave light.

The second laser light LB2 is illuminated onto the first main surface 11 by an optical system that includes a condenser lens or the like. The second laser light LB2 may be illuminated obliquely with respect to the first main surface 11. At this time, the optical axis of the second laser light LB2 may be on the separation surface 13. By moving the irradiation point of the second laser light LB2 along the first intersection line 14, cracks CR are formed over the entire separation surface 13. The cracks CR divide the large plate 10 into the first small plate 20 and the second small plate 30.

For example, a 2D Galvano scanner or a 3D Galvano scanner may be used to move the irradiation point. The movement of the irradiation point may be performed by movement or rotation of the stage holding the large plate 10. For example, an XY stage, an XYθ stage, an XYZ stage, or an XYZ θ stage is used as a stage.

In the present embodiment, the thermal stress is applied to the large plate 10 by irradiation of the second laser light LB2, but the method of applying the stress to the large plate 10 is not particularly limited. A roller may be pressed against the large plate 10 to apply stress to the large plate 10.

The radius of curvature of the curved portion is, for example, 0.5 mm or more, preferably 1.0 mm or more, such that the cracks CR can be easily curved along the curved portion of the first intersection line 14. The radius of curvature of the curved portion is, for example, 1,000 mm or less, and preferably 500 mm or less.

Next, in S4 of FIG. 1, as illustrated in FIG. 5, a temperature difference between the first small plate 20 and the second small plate 30 is applied, and a void G is formed between the first small plate 20 and the second small plate 30. Rubbing between the glass plates can be prevented.

If the temperature of the portion on the side of the center of curvature C (for example, the second small plate 30) is lower than the temperature of the portion on the side opposite to the center of curvature C (for example, the first small plate 20), with reference to the curved portion of the first intersection line 14, a void G is formed between the first small plate 20 and the second small plate 30. The portion on the side of the center of curvature C may be cooled, or the portion on the side opposite to the center of curvature C may be heated.

Note that S4 of FIG. 1 may not be performed, and S5 of FIG. 1 may be performed following S3 of FIG. 1.

Next, in S5 of FIG. 1, as illustrated in FIG. 6, the first small plate 20 and the second small plate 30 are displaced in the direction of the normal to the first main surface 11, and the first small plate 20 and the second small plate 30 are separated. As illustrated above in FIG. 2A, the first intersection line 14 is disposed on one side of the second intersection line 15 in a planar view, and also, the separation surface 13 is inclined with respect to the normal N to the first main surface 11 in a cross-section 16 orthogonal to the first intersection line 14 as illustrated in FIG. 2B. For example, the separation surface 13 is tapered vertically upward, and the vertical direction is the direction normal to the first main surface 11.

Therefore, the first small plate 20 and the second small plate 30 can be displaced in the direction of the normal to the first main surface 11. Accordingly, as illustrated in FIG. 2A, even when the first intersection line 14 of the first main surface 11 includes a curved portion and the first small plate 20 and the second small plate 30 cannot be displaced in a direction parallel to the first main surface 11, the first small plate 20 and the second small plate 30 can be separated without crushing both of the first small plate and the second small plate 20 and 30.

Since the first small plate 20 is a product and the second small plate 30 is a non-product, the separation surface 13 is tapered in a vertically upward direction so that the non-product is pulled out by gravity. When the first small plate 20 is a non-product and the second small plate 30 is a product, the taper of the separation surface 13 may be reversed, and the separation surface 13 may be tapered in a vertically downward direction. When the first small plate 20 is a windowpane for an automobile or cover glass for automotive interior parts, a tilt angle β of the separation surface 13 is determined in accordance with a mounting angle of the first small plate 20. Accordingly, loss, when electromagnetic waves transmitted and received by ancillary parts capable of transmitting and receiving electromagnetic waves pass through, can be reduced. The ancillary part capable of transmitting and receiving electromagnetic waves includes a sensor, a radar of millimeter waves, or the like, which are disposed on the second main surface 22 side of the first small plate 20.

Next, the first small plate 20, which is a product, will be described with reference to FIG. 6. The first small plate 20 has a first main surface 21, a second main surface 22, and an inclined surface 23. The first main surface 21 of the first small plate 20 is a part of the first main surface 11 of the large plate 10. Similarly, the second main surface 22 of the first small plate 20 is a part of the second main surface 12 of the large plate 10. The inclined surface 23 of the first small plate 20 is caused by the cracks CR in the separation surface 13.

The second small plate 30 also has a first main surface 31, a second main surface 32, and an inclined surface 33, similar to the first small plate 20. The first main surface 31 of the second small plate 30 is the remainder of the first main surface 11 of the large plate 10. Similarly, the second main surface 32 of the second small plate 30 is the remainder of the first main surface 11 of the large plate 10. The inclined surface 33 of the second small plate 30 is caused by the cracks CR of the separation surface 13.

### Second Embodiment

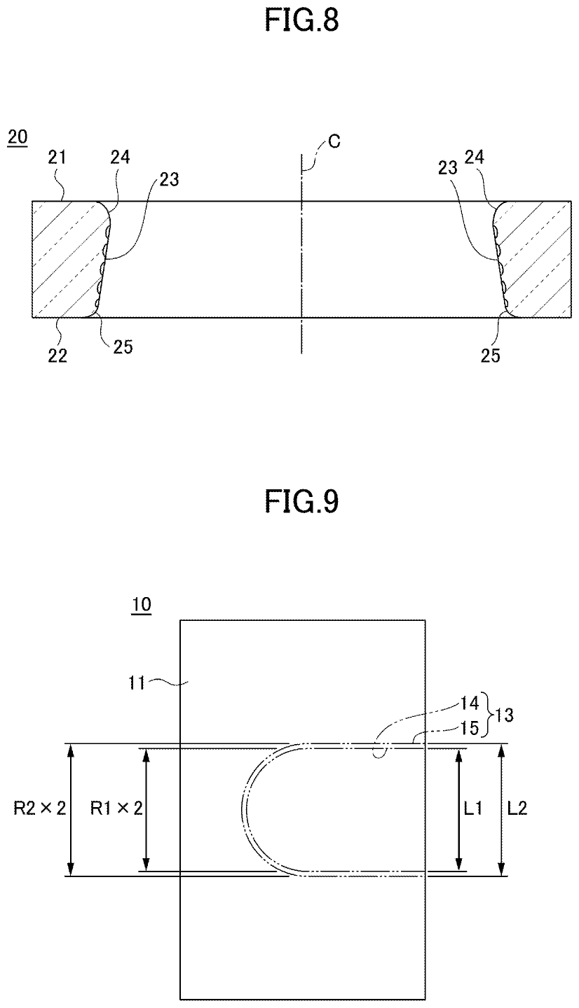

As illustrated in FIG. 7, a glass plate processing method may further include S6 after S5. Hereinafter, S6 of FIG. 7 will be described with reference to FIG. 8. Since S1 to S5 in FIG. 7 are the same as S1 to S5 in FIG. 1, the description thereof will be omitted. However, S4 of FIG. 7 may not be performed in the same manner as S4 of FIG. 1, and S5 of FIG. 7 may be performed following S3 of FIG. 7.

In S6 of FIG. 7, as illustrated in FIG. 8, corners of the inclined surface 23 and the first main surface 21 of the first small plate 20 are chamfered to form a first chamfering surface 24 at the corners. Similarly, corners of the inclined surface 23 and the second main surface 22 of the first small plate 20 are chamfered to form a second chamfering surface 25 at the corners. Machining centers are used for chamfering. The chamfering may be so-called C-chamfering, but in the present embodiment is R-chamfering.

Next, the first small plate 20, which is a product, will be described with reference to FIG. 8. Since the first small plate 20 is a glass plate, the first small plate 20 is hereinafter also referred to as a glass plate 20. The glass plate 20 has the first main surface 21, the second main surface 22, the inclined surface 23, the first chamfering surface 24, and the second chamfering surface 25. Since the first chamfering surface 24 and the second chamfering surface 25 are formed, the chipping of the glass plate 20 can be prevented.

### Third Embodiment

In the first embodiment and the second embodiment, as illustrated in FIG. 2A, each of the first intersection line 14 and the second intersection line 15 is closed. Therefore, the first small plate 20 and the second small plate 30 cannot be displaced in a direction parallel to the first main surface 11.

On the other hand, in the present embodiment, as illustrated in FIG. 9, each of the first intersection line 14 and the second intersection line 15 are open. Both ends of the first intersection line 14 and the second intersection line 15 are coincident (in other words, not present) in FIG. 2A, but are separated in FIG. 9.

The first intersection line 14 illustrated in FIG. 9 is open and intersects at two points on the periphery of the first main surface 11 to divide the first main surface 11 into two areas. A distance L1 between both ends of the first intersection line 14 is not more than twice the average radius of curvature R1 of the curved portion of the first intersection line 14 (in the present embodiment, twice).

Similarly, the second intersection line 15 illustrated in FIG. 9 is open and intersects at two points on the periphery of the second main surface 12 to divide the second main surface 12 into two areas. A distance L2 between both ends of the second intersection line 15 is not more than twice the average radius of curvature R1 of the curved portion of the second intersection line 15 (in the present embodiment, twice).

Even when L1 is twice or less than R1 and L2 is less than twice or less than R2, it is difficult to displace the first small plate 20 and the second small plate 30 in a direction parallel to the first main surface 11. This is because the width of the exit is narrow.

Accordingly, in the present embodiment, as in the above-described first and second embodiment, if the large plate 10 is processed by the processing method illustrated in FIG. 1 or FIG. 7, the desired effect can be obtained.

### EXAMPLE

Hereinafter, a specific example of a glass plate processing method will be described.

### Example 1

In Example 1, S1 to S5 of FIG. 1 was performed. In S1, soda lime glass having a thickness of 3.5 mm was prepared as a large plate 10. The first main surface 11 was a rectangle having a length of 200 mm and a width of 100 mm. The separation surface 13 was a conical base surface tapered vertically upward. The angle β between the normal to the first main surface 11 and the separation surface 13 was 4°. The first intersection line 14 was a circle with a radius of 22.5 mm.

In S2, as illustrated in FIG. 3, the first laser light LB1 is concentrated in a dot shape inside the large plate 10, and a dot-shaped modified portion D is formed at the light concentration point. The modified portion D repeats the two-dimensional movement of the light concentration point in a plane having a constant depth from the first main surface 11 and change of the depth of the light concentration point from the first main surface 11 so that the modified portion D is dispersedly disposed on the separation surface 13. The XYZ stage was used to move the light concentration point.

The irradiation conditions of the first laser light LB1 at S2 were as follows.
Oscillator: Green pulse laser (Spectra-Physics, Explorer 532-2Y)
Oscillation method: pulse oscillation (single)
Light wavelength: 532 nm
Output: 2 W
Oscillation frequency: 10 kHz
Scanning speed of in-plane direction: 100 mm/s
Irradiation pitch of in-plane direction: 0.01 mm
Irradiation pitch of in the depth direction: 0.05 mm
Concentrating beam diameter: 4 μm
Pulse energy: 200 μJ.

In S3, as illustrated in FIG. 4, stress was applied to the large plate 10 to form a crack CR on the separation surface 13. In the formation of the crack CR, thermal stress was applied to the large plate 10 by irradiation of the second laser light LB2. The second laser light LB2 was illuminated onto the first main surface 11 by an optical system that includes a condenser lens or the like. By moving the irradiation point along the first intersection line 14, the cracks CR were formed over the entire separation surface 13. The XYZ stage was used to move the irradiation point.

The irradiation conditions of the second laser light LB2 at S3 were as follows.
Oscillator: Yb fiber laser (IPG photonics, YLR500)
Oscillation method: continuous wave oscillation
Light wavelength: 1070 nm
Output: 340 W
Scanning speed of in-plane direction: 70 mm/s
Beam diameter on the first main surface 11: 1.2 mm.

In S4, as illustrated in FIG. 5, a temperature difference between the first small plate 20 and the second small plate 30 was applied, and a void G was formed between the first small plate 20 and the second small plate 30. Specifically, a cooling spray was sprayed onto the second small plate 30 for 10 seconds.

In S5, as illustrated in FIG. 6, the first small plate 20 and the second small plate 30 were displaced in the direction normal to the first main surface 11, and the first small plate 20 and the second small plate 30 were separated. Specifically, the second small plate 30 was pulled vertically downward by gravity. Subsequently, when the first small plate 20, which is the product, was grasped by a conveying robot and conveyed, no chipping was found on the inclined surface 23 of the first small plate 20.

### Example 2

In Example 2, the large plate 10 was processed under the same conditions as Example 1, except that the angle β between the normal to the first main surface 11 and the separation surface 13 was changed to 21°. As a result, as in Example 1, the second small plate 30 could be pulled vertically downward by gravity. In addition, no chipping was found on the inclined surface 23 of the first small plate 20 due to the conveyance of the first small plate 20, which is a product.

### Example 3

In Example 3, the large plate 10 was processed under the same conditions as Example 1, except that the angle β between the normal to the first main surface 11 and the separation surface 13 was changed to 45°. As a result, as in Example 1, the second small plate 30 could be pulled vertically downward by gravity. In addition, no chipping was found on the inclined surface 23 of the first small plate 20 due to the conveyance of the first small plate 20, which is a product.

### Example 4

In Example 4, the large plate 10 was processed under the same conditions as Example 1, except that the angle β between the normal to the first main surface 11 and the separation surface 13 was changed to 60°. As a result, as in Example 1, the second small plate 30 could be pulled vertically downward by gravity. However, chipping was found on the inclined surface 23 of the first small plate 20 due to the conveyance of the first small plate 20, which is a product.

### Example 5

In Example 5, the large plate 10 was processed under the same conditions as Example 1, except that the angle β between the normal to the first main surface 11 and the separation surface 13 was changed to 2°. As a result, unlike Example 1, the second small plate 30 could not be pulled vertically downward by gravity. Therefore, the conveyance of the first small plate 20 after sampling could not be performed, as a matter of course.

[Summary]

The evaluation results of Example 1 to Example 5 are illustrated in Table 1.

TABLE 1

| | Example | Example | Example | Example | Example |
|---|---|---|---|---|---|
| | 1 | 2 | 3 | 4 | 5 |
| β (°) | 4 | 21 | 45 | 60 | 2 |
| separated | YES | YES | YES | YES | N/A |
| chipping | NO | NO | NO | YES | — |

As can be seen from Table 1, Example 1 to Example 3 illustrated that the β fitted within the range of 3° to 45°, allowed separation and no chipping during conveyance. On the other hand, in Example 4, chipping was found during conveyance because β was too large. Further, in Example 5, the β was too small to be separated.

As described above, the method of processing the glass plate according to the present disclosure and the glass plate have been described. However, the present disclosure is not limited to the above-described embodiments. Various changes, modifications, substitutions, additions, deletions, and combinations are possible within the scope of the claims. These are also naturally within the technical scope of the present disclosure.

What is claimed is:

1. A method of processing a glass plate, which separates a large plate into a first small plate and a second small plate at a separation surface, the large plate being the glass plate having a first main surface and a second main surface facing opposite to the first main surface,
the separation surface intersecting with the first main surface and the second main surface at a first intersection line and a second intersection line, respectively, the first intersection line and the second intersection line including a curved portion,
the first intersection line being disposed on one side of the second intersection line in a planar view, and
the separation surface being inclined with respect to a normal to the first main surface in a cross-section perpendicular to the first intersection line,
the method comprising:
forming a modified portion on the separation surface to be separated by concentrating laser light inside the large plate;
forming, after forming the modified portion, a crack on the separation surface by applying stress to the large plate; and
separating, after forming the crack, the first small plate and the second small plate by displacing the first small plate and the second small plate in a direction of the normal to the first main surface.

2. The method of processing a glass plate according to claim 1, wherein forming the modified portion forms a dot-shaped modified portion on the separation surface to be separated by concentrating the laser light in a dot shape inside the large plate.

3. The method of processing a glass plate according to claim 1, wherein when forming the modified portion, the laser light is illuminated obliquely with respect to the first main surface.

4. The method of processing a glass plate according to claim 1, wherein each of the first intersection line and the second intersection line is closed.

5. The method of processing a glass plate according to claim 1, wherein both of the first intersection line and the second intersection line are open, and
a distance between both ends of the first intersection line is not more than twice an average radius of curvature of the curved portion of the first intersection line.

6. The method of processing a glass plate according to claim 1, wherein a radius of curvature of the curved curved portion of the first intersection line is 0.5 mm or more and 1,000 mm or less.

7. The method of processing a glass plate according to claim 1, wherein forming the crack applies thermal stress to the large plate by irradiation of the laser light.

8. The method of processing a glass plate according to claim 1, further comprising forming, after forming the crack and before displacing the first small plate and the second small plate, a void between the first small plate and the second small plate by applying a temperature difference between the first small plate and the second small plate.

9. The method of processing a glass plate according to claim 1, further comprising forming a chamfering surface at a corner of an inclined surface generated by the crack of the first small plate and the first main surface of the first small plate by chamfering the corner.

10. The method of processing a glass plate according to claim 1, further comprising forming a chamfering surface at a corner of the inclined surface generated by the crack of the first small plate and the second main surface of the first small plate by chamfering the corner.

11. The method of processing a glass plate according to claim 1, wherein the large plate is a bent plate.

12. The method of processing a glass plate according to claim 1, wherein the glass plate is a windowpane for an automobile or cover glass for an automobile interior part.

13. A glass plate comprising:
a first main surface including a curved portion on a peripheral edge;
a second main surface facing opposite to the first main surface;
an inclined surface inclined with respect to a normal to the first main surface in a cross-section orthogonal to the curved portion;
a first chamfering surface provided at a boundary between the first main surface and the inclined surface; and
a second chamfering surface provided at a boundary between the second main surface and the inclined surface,
wherein, in the cross-section, an angle between the normal to the first main surface and the inclined surface is 3° or more and 45° or less.

14. The glass plate according to claim 13, wherein the glass plate is a windowpane for an automobile or cover glass for an automobile interior part.

15. The glass plate according to claim 13, wherein the glass plate has a curved shape.
